(19) United States
(12) Patent Application Publication
(10) Pub. No.: US 2016/0071371 A1
(43) Pub. Date: Mar. 10, 2016

(54) SECURE MONETARY TRANSACTIONAL SYSTEM IN GAMING ENVIRONMENT

(71) Applicant: Joze Pececnik, Kamnik (SI)

(72) Inventor: Joze Pececnik, Kamnik (SI)

(21) Appl. No.: 14/480,613

(22) Filed: Sep. 8, 2014

(51) Int. Cl. G07F 17/32

(52) U.S. Cl. CPC G07F 17/3244

(57) ABSTRACT

A system and method enables transfer of available credit between a gaming apparatus and a non-banking internet source of credit. A gaming apparatus having a ticket-in-ticket-out reading and printing module; an electronic wallet wireless communication system having a wireless communication link to an electronic wireless transaction facilitator; a fingerprint scanner; and a processor. The ticket-in-ticket-out module, the electronic wallet wireless communication system and fingerprint scanner are within a single housing for the gaming apparatus and communication from the processor to the electronic wireless transaction facilitator requires a) scanning of a finger print, b) transmission of scanned fingerprint data to the processor, c) transmission of the scanned fingerprint data to the electronic wireless transaction facilitator; and d) approval from the electronic wireless transaction facilitator is returned to the processor. The processor effects verification of existence of current available credit on the gaming apparatus.

### BACKGROUND OF THE INVENTION

1. Field of the Invention

The present invention relates to the field of enablement of secure financial transactions directly from gaming apparatus to established financial transaction enabling systems.

2. Background of the Art

One important aspect of gaming technology is an ability to allow players to access available funds for use in gaming establishments under highly secure transactional controls. There are both legal and functional issues that must be considered and performed in providing these capabilities. Numerous attempts have been made to provide these services.

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. There is a desire among gaming operators for a system that will allow players to remain at machines even when their funds are low or expended.

There are also legal issues to overcome with respect to financing of gaming play. All US Gaming Jurisdictions will not allow direct charges into EGMs or at gaming tables. For this reason, there are Automated Teller Machines (ATMs) in casinos where players can use the credit card cash advance or debit cards to obtain cash. As the machines cannot be directly tied to gaming, only cash is available at ATM locations and at the cash cage. Gaming kiosks are mainstays within casinos and can include one or more of the following: loyalty points amount verification, Loyalty Club promotions, ATM cash withdrawal, credit card cash advance, and point-of-sale (POS) debit cash advance. Similar to ATMs, the gaming kiosks function to allow for cash withdrawals from banking institutions within set limits and also allow for the cashing out of printed cash vouchers generated by the EGM to the players at ‘cash out’ point of play. Use of ATMs and gaming kiosks require a player to leave his gaming location and/or solicit other players or gaming employees to ‘watch’ and save a position at the machine while funds are accessed at another location. The ATMs and gaming kiosks usually have strict limits on the amounts of cash that can be dispensed at any time, many times limited by state gaming statute

It is desirable for the casinos and the players to develop a funding mechanism for the players that can be exercised in a short period of time and does not require the player to leave what may be a preferred gaming station. Accordingly, there exists a demand for improved customer service capability in the mobile wireless regime that allows for transfer of funds and enhancing the capability of the player to interact with account information.

US Published Patent Application Document No. 20130203483 (Joshi) describes a virtual currency based online social wagering system and method, based on at least one wagering network server. The system can handle wagers initiated by multiple users using commonly available computerized devices such as smartphones. The system avoids legal problems through the use of virtual currency rather than money (which makes the interactions wager-like events, rather than actual wagers), and facilitates interactions between friends by drawing upon social networks for much of the interactions. The system is also designed to make friendly social interactions such as banter, “trash talk”, or “swagger” a key part of the wagering experience. Various internal controls insure that the virtual funds are managed correctly.

US Published Patent Application Document No. 20110077073 (Gagner) describes a wagering game account management system and its operations. In embodiments, the operations include presenting a graphical user interface that includes a graphical control associated with a credit account belonging to a wagering game player; detecting a selection of the graphical control that initiates a financial transaction to transfer money from the credit account to a wagering game session account; determining access information stored in a player profile, the access information to access the credit account; determining an amount to transfer from the credit account to the wagering game session account balance; determining one or more rules limiting use of the credit account; and enforcing the one or more limitation rules on the use of the credit account.

US Published Patent Document 20140018155 (Nelson) describes a gaming system compatible with patron-controlled portable electronic devices, such as smartphones or tablet computers. When a player surpasses predetermined game play parameters on a game of an EGM, a bonus game or related game material may be “unlocked” and offered to the player for download onto the player's Portable Electronic Device (PED). Upon installation, the game or content may be viewed or played on their PED at a later time and at their leisure.

US Published Patent Document 20110040655 (Hendrickson) describes a real time management system for marketing to customers and vendors with customer purchasing and preference data in specific consumer markets including restaurant, retail, travel, hospitality, entertainment, and combinations thereof. The management database allows the consumer to make Precision Purchasing™ transactions, reservation transactions, and Precision Gifting™ transactions via a web-based interface, POS based touch screen interface, and mobile device-based interface. The consumer profile database is comprised of mainly consumer inputted preference and consumer purchase data which is stored into each customer profile and can be accessed/verified with a GPS recognition of the customer's phone, biometric hand or finger scan, access card, retinal scan, password, key fob, or other terminal kiosk, touch screen, or mobile application of the like. All data inputted into the Precision Marketing™ system will be stored in each consumer's personal/business account. Only consumer-authorized parties may access the account holder's personal preference information for the purposes of Precision Gifting™ and Precision Purchasing™, but he/she may never access the customer's confidential information. All changes made to each profile and the purchase preference information will be updated in real-time. All reservations, fund transfers, purchases, and other transactions are stored in the central database system and used for the purposes of Precision Marketing™ and Precision Gifting™.

Published U.S. Patent Application Document Nos. 20140090953 and 20140090952 (Johnson) enables a bezel assembly for data reception, for use with a bill validator in a financial transactional device, includes a bezel housing and a data reception assembly. The bezel housing includes a customer-facing front portion and a back plate connectable to the bill validator that is mounted within the transactional device cabinet. The front portion includes an insertion/dispensing slot for receiving currency and a projecting protrusion forward of the casing. The forward-extending protrusion accommodates at least a portion of the data reception assembly. The bezel assembly can include a wireless communication function that is communicably connectable with a mobile device via a wireless communication method, a manual entry function, a biometric reader, one or more cameras for scanning and decrypting 2D barcodes and the like, thus enhancing the overall functionality of the financial transactional device.

Published U.S. Patent Application Document No. 20130231180 (Kelly) describes a system and method which provides for biometric identification at a first server of an identified user and an established anonymous user and a device such as a gaming device and for using a second device such as a cellular telephone interfacing with the device to also access a second server which may also store biometric information as well as chargeable account information. If a user cannot be identified the first server establishes a new anonymous player account. Location determination may also be used where use of the device is subject to area use restrictions, such as remote gaming, to enable or disable the restricted use.

Published U.S. Patent Application Document No. 20130130779 (Gagner) A wagering game system and its operations are described herein. In some embodiments, the operations can include initiating a wagering game session for presentation of wagering game content. The operations can further include scanning a coded identifier during the wagering game session. The coded identifier indicates a characteristic associated with activity, events, achievements, etc. performed or attained prior to initiation of the wagering game session. For instance, the coded identifier can be a two-dimensional barcode generated in response to online activity (e.g., in response to progress attained in an online game). In some embodiments, the characteristics indicate information about the activity. The operations can further include adapting the wagering game content during the wagering game session based, at least in part, on the characteristic indicated in the coded identifier, such as providing gaming rewards and bonus games, adding funds, unlocking content, modifying wagering game content, etc.

Published U.S. Patent Application Document No. 20120252567 (Gagner) describes systems and methods for managing of cashless wagering game systems. An apparatus comprises a control module to debit, via a first system access technique, a debit amount from a first cashless wagering system in a financial transaction and credit, via a second system access technique different from the first system access technique, a credit amount to a second cashless wagering system in the same financial transaction, the first and second cashless wagering game systems being different from one another coupled over a network, When a player wants to play a wagering game using the funds in their player account, they may check out a PGT (portable gaming tablet). In an embodiment, the player may provide a player authentication to obtain a PGT. A player authentication screen, which may be presented after the player chooses “Checkout Tablet” from the main menu, in accordance with an embodiment. The player authentication may be a personal identification number (PIN) or in other embodiments, the player authentication may include biometric information, such as a fingerprint scan. After successfully entering the player authentication information, the cashless wagering kiosk 310 presents a checkout screen.

Published U.S. Pat. No. 8,814,700 (Vlazny et al.) describes a method and apparatus for use in a wagering environment. An exemplary embodiment of the present invention comprises a wagering terminal including a processor, a memory, a primary display, and a secondary display. The primary display is configured for displaying visual messages. These visual messages are displayed as part of a graphical user interface and include at least one wagering transaction message. The secondary display is configured for displaying additional visual messages associated with the visual messages of the primary display. These additional visual messages are displayed as part of an additional graphical user interface. The wagering terminal may further include a proximity detector configured for detecting the presence of a gaming patron, a user identification unit configured for sampling a unique physical attribute of a user, and an image capture unit configured for capturing at least one image in a vicinity of the wagering terminal. A separate fingerprint reading system may be combined as a component in the system.

Another major aspect of gaming technology is the advent of ticket-in-ticket out technology as a convenient method of providing, conveying and depositing economic value in the gaming environment. Within gaming establishments, such as casinos, gaming devices are typically networked via a central computer. Such configuration allows for the gaming establishment to monitor a player's gameplay for tracking purposes. Gaming devices typically issue paper tickets that are redeemable for cash. These paper tickets can be redeemed either at assisted-service counters (i.e., a casino cage) or through self-service computer systems, sometimes called Ticket-In-Ticket-Out (TITO) machines. Drawbacks of using paper tickets, however, is that the players may very easily lose tickets, tickets can become destroyed or damaged, casinos incur cost from replenishing tickets, and casinos incur cost for maintaining ticket printers. Additionally, the use of tickets requires that operators of casinos ensure that sufficient amounts of cash are available on the gaming floor to accommodate redemptions at both the assisted-service counters and the TITO machines. Players wishing to play a table game at a casino typically first exchange cash for an amount of chips which can then be used for gaming. When the player wants to convert the chips back to the cash, the player typically exchanges their chips for an equivalent amount of cash at a cashier cage at the casino. Thus, in addition to ensure sufficient cash is available for ticket redemptions, operators of casinos must ensure also sufficient amounts of cash are available at the cashier cage to accommodate player exchanging chips for cash. This process for routinely replenishing cash by the casino operator is both costly and burdensome.

Major advances in the development of ticket-in-ticket out technology were originally disclosed in the following references. All documents cited in this text are incorporated by reference in their entirety.

U.S. Pat. No. 8,777,725 (Sanford) describes a transaction facilitation system that is configured to affect substantially real-time crediting and debiting of a gaming accounts maintained within a gaming environment and structured to communicate by a private restricted communication link with an issuing financial institution of a stored value account to effect real-time crediting and debiting of the stored value account. Financial transactions using the stored value account can be and used customer relationship purposes.

U.S. Pat. Nos. 6,500,067 and 6,679,775 (Luciano) disclose a flexible, adapable voucher gaming system having a LAN interconnecting a cashier terminal, a central voucher-record database server, one or more logical gaming controllers, and a plurality of player terminals in order to play games of chance at each player terminal, and cashless transactions in Nevada-style casinos, bingo halls, Amerindian casinos, and the like. The system provides voucher printers at the cashier terminal and preferably at the player terminals as well. The vouchers include unique bar codes printed on the vouchers, and the bar codes are readable by scanners at the cashier terminal and at the player terminals. The player terminals are preferably adapted to provide the player with the option of receiving at least certain amounts of cash rather than a voucher, but to also ensure that at least a voucher is provided to the player in the event that the player terminal fails to dispense cash when earned by the player and payable to the player under the game rules at the player terminal.

U.S. Pat. No. 6,012,832 (Saunders) describes a cashless peripheral device connecting to a gaming system. The gaming system issues a “cash-out” signal when a player quits playing and receives a “cash-in” signal when a player desires to play a game in the gaming system. A stack of continuous unprinted tickets is stored in the interior of the device. A ticket printer prints a coded value, such as a bar code, on a ticket in response to a cash-out signal from the gaming system. A ticket reader reads the amount printed on the ticket. If the printed value corresponds to the value which should have been printed, a ticket-out transport delivers the printed ticket to the player cashing out from the gaming system. When a player inserts the printed ticket into the device a ticket-in transport senses the insertion and the ticket reader reads the coded value from the inserted printed ticket. The ticket reader issues a cash-in signal to the gaming system corresponding to the value read from the coded value on the inserted printed ticket. After reading, the ticket is delivered into a ticket bin, which is secured by means of a lock internally in the housing.

U.S. Pat. No. 6,048,269 (Burns) enables a gaming apparatus which comprises a slot machine capable of accepting either paper currency, preprinted coupons, or cash out slips. The slot machine also includes a printer that prints and dispenses cash out slips which include a bar code representing a unique identification that provides the amount of “winnings”. The cash out slips can be scanned into a separate currency dispenser at a Cashier's Station for receiving currency, either from the dispenser or from an attendant. A central processing unit (CPU) generates the unique codes for regulating the game to be played, the wager limits of the game and the validity of the free play coupons or the cash out tickets. The above gaming system avoids having to use coins or tokens in the operation of slot machines.

Economic transfer systems and fingerprint security components are well known in the art as independent components. These are shown in the following documents.

Published U.S. Patent Application Document No. 20090124376 (Kelly) discloses networked gaming systems with anonymous player biometric identification and tracking, and associated methods. Also disclosed are a responsible gaming system and method, an anonymous player Bonusing method and system, a money laundering identification system and method, a distributed casino surveillance system and on electronic gaming machines, and a method and system for electronic re-configuration and/or download of a gaming machine based upon anonymous player identification using biometrics at the gaming device. For example, % it is not uncommon for fingerprint % identification software to require % four to six points to be identifiable % as a threshold, prior to a % fingerprint being viable for % comparison and reliable matching % with a fingerprint database.

Published U.S. Patent Application Document No. 20060283934 (DeRaedt) discloses a note validating and storage assembly for a gaming table having a table top includes a storage box for storing notes received at the gaming table. A validator is disposed adjacent to the storage box for validating the authenticity of the notes and determining the value of the notes. A controller having a memory is in operative communication with the validator for receiving and storing data corresponding to the authenticity and value of the notes. A separator apparatus is disposed adjacent to the validator. The separator apparatus grips one of the notes and separates the one note from a plurality of notes. A holding area is operatively connected to the separator and configured for temporarily holding at least one note in a folded configuration. The holding area is disposed below the table top such that notes may be pushed through a note entry slot in the table top and into the storage area with a plunger. A method of tracking the value of notes received from a player is also disclosed.

Published U.S. Patent Application Document No. 20060068869 (White) discloses a system and method provides an electronic poker game to a plurality of players using an electronic poker table. The electronic poker table has a table top with a playing surface and a plurality of electronic player interaction areas located around a periphery of the table top. Each electronic player interaction area provides a player interface for interaction with one of the players. The electronic poker table includes at least one device coupled to the electronic poker table for reading tickets having an associated value. A game computer administers the electronic poker game by using electronic cards and electronic chips, associates the value of a first ticket read by the at least one device with one of the players and allows the one player to purchase electronic chips with at least a portion of the value of the first ticket.

Published U.S. Patent Application Document No. 20040147309 (Chamberlain) describes an apparatus, system and method for electronically transferring funds at a gaming device. The gaming device has a ticketing system that includes a ticket reader. The system also includes an electronic fund transfer (“EFT”) kiosk that enables a patron, using a credit, debit, smart, casino or combination type card to enter a request for funds. The kiosk has a controller that sends a request out over a banking network for approval or denial. If approved, the kiosk includes a ticket printer that prints a ticket having a bar coded fund transfer. The player can use the ticket at one of a variety of gaming devices to receive game credits or redeem the ticket for cash.

Published U.S. Patent Application Document No. 20130321606 (Fenrich) discloses a large format fingerprint capture apparatus, system and method that is low power, compact, and lightweight and has a platen area greater than 3.0 square inches. The present system is typically powered, controlled, and exchanges data over a single data/control/power connection to a host PC, e.g., a desk top computer, PDA, or laptop computer although the system can also be used in a wireless fashion with a power subsystem so no physical connections are required. The system typically includes a light source, a prism, a camera (including the lens), and a case. Optional elements comprise holographic elements such as gratings and holographic optical elements (HOEs), a battery subsystem, magnetic stripe reader, barcode reader, platen heater, platen blower, and mirrors to divert the image beam. This application discloses many different technologies for original development of electronic files and images of fingerprints. To achieve minimal size and weight the number of components is minimized in the system, apparatus, and method of the present invention. Technology for aspect ratio changes, image aberration corrections, and perspective corrections may be used to minimize the depth of field, as taught by U.S. Pat. Nos. 5,629,764 and 6,061,463, which are incorporated herein by reference. Alternatively, aspect ratio, image aberration, and perspective corrections can be made algorithmically via hardware, firmware and software as provided for in the present invention.

Ojanen, see Appendix A, teaches one way of removing image aberrations and perspective distortions via such algorithms. Also, technology may be used to maximize the amount of light generated per watt, as taught, by U.S. Pat. No. 5,359,691 to Tai et al., U.S. Pat. No. 5,390,276 to Tai et al., and U.S. Pat. No. 5,854,872 to Tai, which are hereby incorporated by reference as if fully set forth herein. As disclosed in U.S. Pat. Nos. 5,629,764 and 6,061,463 incorporated herein by reference, technologies to reduce the required depth of field to near zero exist. These technologies typically work by redirecting the light in the device with holographic gratings or other suitable replacements. Any optical technology that allows the object plane and image plane to be properly aligned suffices but, the added advantage of the holographic elements as disclosed in U.S. Pat. Nos. 5,629,764 and 6,061,463 is that they take a small amount of space. Since the object plane and image plane are properly aligned, there is no need for heavier and more space consuming optics to perform optical image correction.

Published U.S. Patent Application Document No. 20120321149 (Carver) describes a sensor for detecting fingerprints is provided having first and second substrates, a two-dimensional array of sensing elements formed on the first substrate, and a plurality of thin-film transistors or TFTs for controlling the sensing elements at pixel location along the array. Each of the sensing elements detects one of electrical signals (e.g., capacitance, resistance, or impedance), temperature, or light via one of the first or second substrates representative of one or more fingerprints. The top of the second substrate or the bottom of the first substrate may provide a platen upon which one or more fingers can be disposed. The sensor may be utilized in a fingerprint scanner having one or more processors driving sensing elements or reading from sensing elements analog signals representative of one or more fingerprints, and generating an image representative of the one or more fingerprints from the analog signals.

### SUMMARY OF THE INVENTION

A system for enabling a method for transfer of available credit between a gaming apparatus and a non-banking internet source of credit may include:
a gaming apparatus having a ticket-in-ticket-out reading and printing module;
an electronic wallet wireless communication system having a wireless communication link to an electronic wireless transaction facilitator;
a fingerprint scanner; and
a processor;
   wherein the ticket-in-ticket-out module, the electronic wallet wireless communication system and fingerprint scanner are within a single housing for the gaming apparatus and wherein communication from the processor to the electronic wireless transaction facilitator requires a) scanning of a finger print, b) transmission of scanned fingerprint data to the processor, c) transmission of the scanned fingerprint data to the electronic wireless transaction facilitator; and d) approval from the electronic wireless transaction facilitator is returned to the processor; and
   wherein a further requirement of communication between the processor and the electronic wireless transaction facilitator requires processor verification of existence of current available credit on the gaming apparatus; and
   a user of the gaming apparatus transfers credit from the electronic wireless transaction facilitator to the gaming apparatus or from the gaming apparatus to the electronic wireless transaction facilitator.

### BRIEF DESCRIPTION OF THE FIGURES

FIG. 1 is an image of a Ticket-in-Ticket-out ticket with both a bar code and QR code on the ticket.

FIG. 2 is a schematic of components in a processor based system that may be included within the architecture of the present technology.

FIG. 2A is a front perspective view of an electronic video gaming apparatus which may be used in the practice of the present technology.

FIG. 3 is a further schematic of components in a processor based system that may be included within the architecture of the present technology.

### DETAILED DESCRIPTION OF THE INVENTION

A multi-location system enables a method of transferring available credit between a gaming apparatus and a non-banking internet source of credit. Available credit is actual monetary value that is available for use or transfer either within the direct control of a casino or within a financial institute enabled by law to hold and transfer funds electronically. The system may include:

a gaming apparatus (e.g., video game, electronic poker machine, electronic gaming table such as electronic roulette, electronic craps, electronic playing card games, and the like) having a ticket-in-ticket-out reading and printing module. The system also includes an electronic wallet wireless communication system having a wireless communication link to an electronic wireless transaction facilitator, which is a distal (from the gaming apparatus and even from the casino or gaming establishment). The gaming apparatus has attached thereto a fingerprint scanner; and a processor. These components will be described in greater detail herein.

The ticket-in-ticket-out module, the electronic wallet wireless communication system and fingerprint scanner are within (including by definition physically attached to) a single housing for the gaming apparatus. Communication from the processor to the electronic wireless transaction facilitator requires a) scanning of a finger print, b) transmission of scanned fingerprint data to the processor, c) transmission of the scanned fingerprint data to the electronic wireless transaction facilitator; and d) approval from the electronic wireless transaction facilitator is returned to the processor. The scanning of fingerprints may require even two separate scans to assure authenticity during verification. A further requirement of communication between the processor and the electronic wireless transaction facilitator might include separate processor (in the gaming apparatus) verification of existence of current available credit on the gaming apparatus. A user of the gaming apparatus may then transfer credit from the electronic wireless transaction facilitator to the gaming apparatus or from the gaming apparatus to the electronic wireless transaction facilitator.

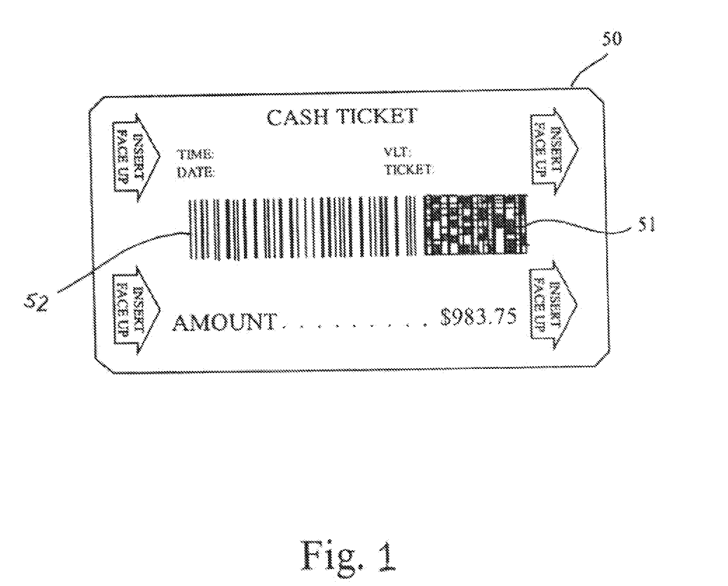

FIG. 1 shows a novel TITO (ticket-in-ticket-out) slip 50 having both a QR code 51 that can be scanned and a typical bar code 52 that may also be scanned. The qr component can provide unique functionality to the system by directing external search functions to a distal server through internet and wireless connectivity to access credit information, account access, fingerprint stored data, player accounts and the financial institution credit storage and credit transfer ability (e.g., the later described eWallet-type account). The single QR code can contemporaneously access all such external accounts and records and enable verification and authorization for credit transfers on demand. The QR code may engage through the internet any one of or all of the player account, the casino gaming servers, the eValet or eWallet account (the distal financial/credit source account) and the gaming apparatus. By engaging all accounts or multiple accounts at the same time, the player may legally transfer funds into credit accounts (player account, the gaming apparatus or eWallet-type account), shift funds among accounts and check status of each account.

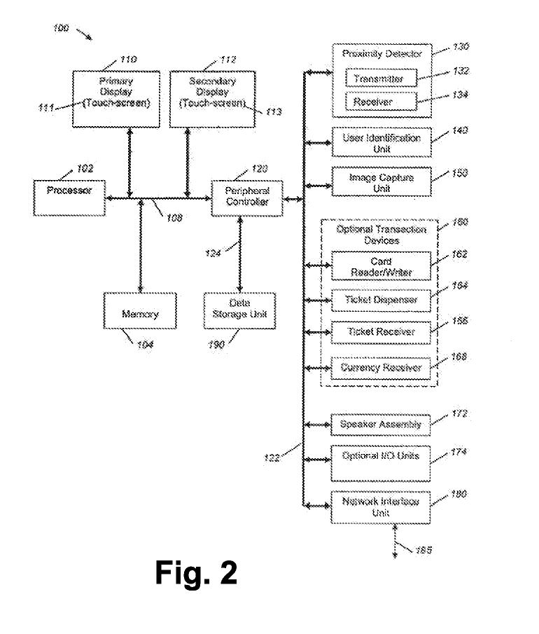

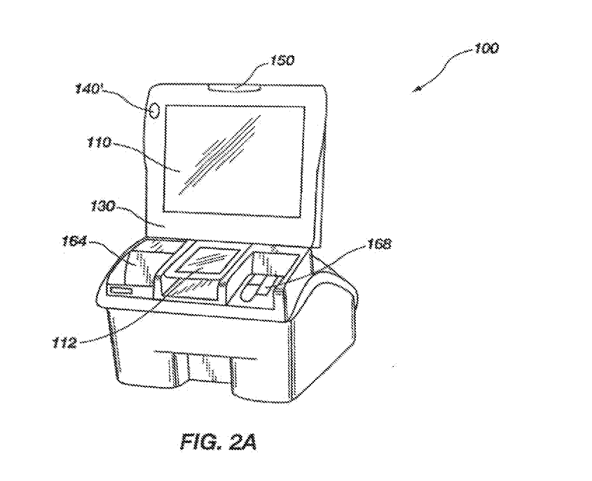

An ability to implement enhanced security measures is a significant aspect of the present invention illustrated in FIG. 2. To support these enhanced security measures, some embodiments of the present invention may include a user identification unit 140. The user identification unit 140 may be used to capture information biometric (i.e., unique physical attributes of the user) about a user. In the presently preferred embodiment, the user identification unit 140 is a fingerprint reader 140′ for use in teller-assisted mode to identify an authorized teller. The fingerprint reader 140′ may be used as an identification aid for teller sign-on to the wagering terminal 100. In an exemplary embodiment, the fingerprint reader 140′ includes a small sensor, which reads characteristics of a fingerprint. The wagering terminal 100 may store these characteristics (also referred to as a user unique data element) in a local or a remote user database. The characteristics may be compared to the user database of authorized fingerprint characteristics to verify that the teller may sign-on. The fingerprint reader 140′ may also be used in conjunction with a secondary identifier, such as, for example, an employee number entered on the primary touch screen 111 or keyboard 180′ a personal identification number, or an identification card read by a card reader/writer 162 (FIG. 2A). With a secondary identifier, there is no need for a search engine to find the characteristics of a given fingerprint. Instead, the secondary identifier may be used as a pointer to an entry in the user database. The fingerprint characteristics for that user database entry may then be compared to the fingerprint characteristics from the fingerprint reader 140′. Once the user is identified and verified as an authorized user, the wagering terminal 100 may enable additional protected features, which should only be available to authorized users.

An aspect of the control logic to capture fingerprints is how to determine when to start capturing a print and when to stop capturing a print. In preferred embodiments of the apparatus, system and method of the present invention, this control logic is implemented in software since the frame rate of the images delivered by the camera is high enough to allow processing on the host computer that algorithmically identifies a starting frame and an ending frame for each fingerprint capture. Typically, for a single finger roll the real frame rate is 20 frames or more per second, which results in a 12-13 or more processed frames per second rate. Typically, for a four finger slap image the real frame rate is at least 6 frames per second which results in an at least 4 processed frames per second rate. As a rolled fingerprint is being captured frame-by-frame, individual frames are analyzed and combined into a rolled print so that when the ending frame is identified, the combined rolled image is complete. Preferably, the frame rate for a rolled image is sufficient to obtain a real-time image. In one embodiment, the apparatus, system and method of the present invention provide a light source and camera combination that has a power and light efficiency that allows a large format fingerprint device to be powered, controlled, and to exchange data digital image frames over a single connection, such as a USB 2.0 cable connection. Alternative embodiments include FireWire 1.0, FireWire 2.0 and next generation peripheral interfaces. Alternative embodiments also include a power subsystem wherein a battery or capacitor is charged during periods of low power consumption and when more power is required more power is drawn from the power subsystem.

To compute the fingerprint location in each frame, two histograms are generated. The histograms are based upon image variance and are calculated only on each row and column index that is evenly divisible by the estimated fingerprint ridge width. The variance of the grayscale values of the pixels is calculated over an area roughly equal to the width of two ridges on the current frame for every pixel whose row and column is evenly divisible by the estimated ridge width, and whose area resides entirely within the current frame. If the variance of the pixel is greater than a pre-set threshold, then the associated positions in each histogram are incremented. Once the two histograms have been generated, the first and last entries in each histogram that are above a pre-set tolerance provide a rectangle encompassing the location of the fingerprint.

An automatic trigger process employs the current and previous fingerprint bounding box locations to determine finger travel distance and direction between frames. The center column of each fingerprint is calculated as the middle of the corresponding bounding box determined by a step. The centers of the current and previous locations are compared to determine if the fingerprint is moving and if so, which direction the finger is moving. If the Euclidian distance between the centers of the locations is less than or equal to a predetermined number of pixels, the fingerprint is determined to be stopped. If the current frame center is greater than a predetermined number of pixels right of the previous frame, the fingerprint is determined to be rolling right. If the current frame center is greater than a predetermined number of pixels left of the previous frame, the fingerprint is determined to be rolling left. The predetermined number of pixels is typically at least about 10.

A half roll in one direction is started with a frame whose roll direction is either left or right (the direction of the half roll). The half roll is composed of a sequence of frames that have a direction of either stopped or direction of the half roll. The half roll is completed when the current frame's roll direction is opposite the direction of the half roll. If the half roll has a sufficient number of frames with a roll direction equal to the half roll direction, the full roll is begun and the capture sequence is started. Otherwise, the software returns to waiting for a half roll. The full roll is composed of a sequence of frames with roll directions opposite the direction of the half roll direction, not including stopped. The full roll is completed when the roll direction of a frame is not equal to the direction of the full roll or a sufficient number of stationary frames have been captured. If a sufficient number of frames are reached between the beginning of the full roll and the end of the full roll, the software accepts the full roll as complete. If the number of frames is insufficient, the system cancels the full roll and returns to waiting for a half roll. If at any point during the rolls the finger is removed from the platen, the software returns to waiting for a half roll.

When a roll starts or is cancelled, the composite image that represents the fingerprint roll is initialized. As frames from the camera are captured, they are processed by applying offset and gain, fingerprint location, and trigger condition analysis. If the cancel condition is indicated then the current fingerprint roll is halted and the process returns to the beginning of the fingerprint roll process. If, instead, the end roll condition is set then the composite image is post-processed. If there is no trigger condition set, then the current frame is merged into the composite image to create a composite roll image from a sequence of frames. The process of grabbing and processing frames continues in this manner until the roll end trigger occurs. The roll end trigger signals the end of the capture sequence.

For a roll, merging into a composite image is done in five steps: 1) identifying where the current composite image and new fingerprint image overlap, 2) calculating the direction of the roll, 3) computing an initial splice line by roughly aligning the fingerprint ridges between the composite image and new fingerprint image, 4) use a quality metric to refine the splice line from the top to the bottom of the image, 5) combine the new image frame into the merged composite image using morphing along the splice line.

Any overlap area between the merged composite image and the new fingerprint image has been described above. The direction of the roll can be determined by computing which side the new fingerprint image is located. For example, if the new fingerprint image is located on the left side of the composite image then the roll direction is to the left.

An initial splice line may be created by forming an initial splice line based on the endpoints where the new fingerprint image and the composite fingerprint image intersect in the overlap area then compute the slope of this new splice line segment. Compute the center of this new splice line segment. Determine which two fingerprint ridges, near the center of the new image and the merged composite image, have the best alignment. A metric that can be used is the local gray scale average along the splice line. This center location of the splice line is updated so to this identified best match point so that splice line refinement can occur at this reliable anchor point. Copy this new splice line and its center location and call it the composite splice line.

Splice line refinement may be provided by starting from the center of the new splice line segment iterate up the splice line segment a pre-determined number of pixels at a time. The starting position and the ending position on the splice line identify an area of the splice line that is being refined. In the top row of this refinement region, iterate from a threshold number of pixels left of the splice point to a threshold number of pixels to the right of the splice point. Form a splice line segment candidate from the iterated pixel to the starting position on the splice line. Compute a common similarity metric between all candidate splice line segments so formed. One similarity metric computes the pixel intensity average of the two areas and compares the averages. The result of the comparison is a score that represents how close these two areas match, which represents how well the ridges line up. Once all the comparisons are done, the best refined pixel location becomes the new point on the composite splice line for this particular row. This process iterates to the top of the overlap area and from the center of the splice line segment to the bottom of the overlap area. The result is a final composite splice line based on the initial splice line.

Morphing (merging) components into a composite image can be done with the existing composite image and new fingerprint image form a new composite image. The initial splice line and composite splice line control what region of the composite image gets blended with the new fingerprint image region. Iterate from the bottom of the overlap region to the top of the overlap region along both splice lines simultaneously. For each row consider the pixels on that row between the splice lines and a pre-determined threshold number of pixels outside of the splice lines. Iterate across this interval of pixels on the row and assign the value of the composite image at that location as a value weighted by distance between the two splice lines. Thus, data from the merged composite image is morphed into the data from the new fingerprint image.

A computing machine including a sensor to capture a fingerprint image from a user and generate a password in response to the user accessing the sensor, a component to create a package of the fingerprint image and the password, and a processor to authenticate the fingerprint image from the package before decrypting an encryption of the password if a request for the password has been received before a predefined time has elapsed. The sensor can capture the fingerprint image from the user in response the user accessing the sensor. The user can access the sensor by physically touching the sensor with a finger. The sensor can detect the finger of the user and proceed to capture an image of the user's fingerprint. The fingerprint image can be created as data, information, and/or as a file by the sensor. In other embodiments, the sensor can perform a retina scan of the user and/or capture any additional information from the user in addition to and/or in lieu of those noted above.

The sensor can also generate a password in response to the user accessing the sensor. The password can be used by the device to authenticate the user and/or to verify an identity of the user. In one embodiment, the password can be a one-time-password (and even the QR code on a ticket as shown in FIG. 1) which can be randomly generated by the sensor in response to the user accessing the sensor. The password can include one or sequence of numbers or characters. In another embodiment, the password can include one or more digital signatures. In other embodiments, the password can include any additional information which can be utilized by the device to verify an identity of the user.

In one embodiment, the fingerprint image and/or the password can additionally be encrypted by the sensor. When encrypting the fingerprint image and/or the password, the sensor can utilize one or more encryption algorithms. In another embodiments, the sensor can encrypt the fingerprint image and/or the password using one or more keys. In other embodiments, the sensor can utilize one or more software/hardware tokens and/or any additional method to encrypt the fingerprint image and/or the password in addition to and/or in lieu of those noted above.

Using the encrypted fingerprint image and the encrypted password, a component of the computing machine can generate a package to include the fingerprint image and the password. As noted above, the component can be a software component, such as a firmware driver of the sensor. The component can generate the package of the fingerprint image and the password as a BLOB (Binary Large Object). In other embodiments, the component can generate the package as any additional type of file, data, and/or cluster which can include the fingerprint image and the password 245 in addition to and/or in lieu of those noted above.

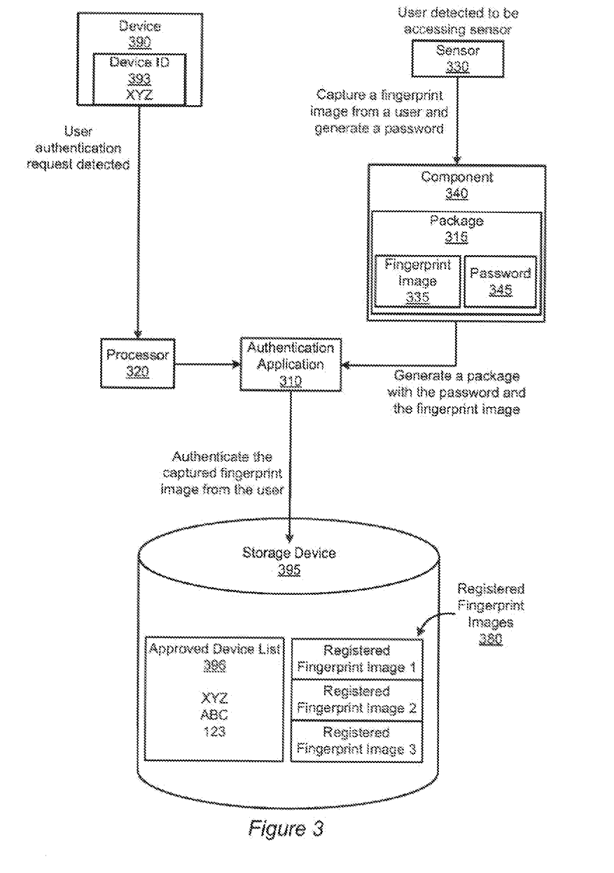

FIG. 3 illustrates a block diagram of a fingerprint image 335 being captured and a password 345 being generated in response to a processor 320 and/or an authentication application 310 receiving a user authentication request according to an embodiment. As illustrated in FIG. 3, the processor 320 has detected a user authentication request. As noted above, the user authentication request can be sent to the processor 320 and/or the authentication application 310 by a device 390 coupled to the computing machine. In one embodiment, before processing the request, the processor 320 and/or the authentication application 310 can authenticate the device 390.

The processor 320 and/or the authentication application 310 can prompt the device 390 for an identification 393 of the device 390 and compare the identification 393 to an approved device list 396. The approved device list 396 can be stored on the computing machine and can list one or more devices which the processor 320 and/or the authentication application 310 determine to be secure. If the device 390 not on the approved device list 396, the processor 320 and/or the authentication application 310 can reject any requests from the device 396. If the device 396 is on the approved list, the processor 320 and/or the authentication application 310 can proceed to process the request and notify the sensor 330.

As shown in the present embodiment, the device 390 may include a device ID 393 of XYZ and XYZ is included in the approved device list 396. As a result, the device 390 is determined to be secure and the sensor 330 proceeds to detect a user accessing the sensor 330. In response to detecting the user accessing the sensor 330, the sensor 330 proceeds to capture a fingerprint image 335 from the user and proceeds to generate a password 345. The fingerprint image 335 and the password 345 can then be shared by a component 340 of the computing machine. In one embodiment, the sensor 330 can additionally encrypt the fingerprint image 335 and/or the password 345 using one or more of the methods noted above before sharing the fingerprint image 335 and the password 345 with the component 340.

Using the fingerprint image 335 and the password 345, the component 340 can proceed to create a package 315. As noted above, the package 315 can be created as a BLOB, which can include the fingerprint image 335 and the password 345. The package 315 can be shared with the processor 320 and/or the authentication application 310. In one embodiment, the component 340 can further encrypt the package 315 itself.

Preferably, the fingerprint scanner may include arrays of TFT (thin film transistors) and coupled sensor(s) thereto are in 2D orthogonal grids. As the sensor of the present invention avoids the need for free-space optics described earlier, the magnification of the fingerprint(s) detected when light sensing elements are present is typically 1:1, but may be a slightly higher magnification in one axis due to the presence of a tilted platen as in the case of a prism element. For systems that have 1:1 magnification, the maximum pixel size desired for AFIS (Automatic Fingerprint Identification Systems) corresponds to 50.8×50.8 μm which translates to 500 points-per-inch (ppi). For a system that incorporates a 45 deg prism, the maximum pixel size is 50.8*sin(45)=35.9 μm.

In each pixel element of the array is a TFT to allow for individual driving and/or enabling reading of an analog value by the processor(s). Such may be enabled by drive/read electronics to the TFTs. Each pixel element may contain one or more of the following sensing elements: a light sensor, light source, capacitance sensor, resistance sensor, impedance sensor, and thermal sensor.

For the optical measurement of a fingerprint pressed in contact with a platen surface, at a minimum a light sensor per pixel is needed for where the sensing element detect light. For optically sensitive TFT pixels, illumination by the fingerprint scanner may come from a light source external to the TFT sensor array such as from a light panel or light guide underneath the sensor (since it is printed on top of the first substrate and a portion of each pixel may be transmissive to allow light to transmit from underneath the array and illuminate a fingerprint that is above the first substrate of the sensor). Alternatively, the light source may be provided at each pixel of the array. By way of example, for a light sensing element may be a PIN photodiode, a LED (light-emitting diode) or an OLED (organic light-emitting diode). Additionally or in place of, other modes of detection by the sensing element may be used for measuring the electrical characteristics of the skin (resistance, capacitance, impedance) or temperature may be incorporated into each pixel. The electrical characteristics of the fingerprint may be the primary method for extracting the minutia detail required for enrollment, identification, and/or verification, or may be a complementary method used in order to determine that a fingerprint presented to the scanner system is an actual live finger and not a spoof or a dead finger. By incorporating electrical and/or temperature measurement systems, the scanner becomes more difficult to fool or spoof. By way of example, the array of the sensor may have at each pixel an optical sensing element and an electrical sensing element and in this manner be able to image a subject's fingerprint both optically and electrically. Alternatively, a TFT-based array may have predominantly one type of sensing elements for the purposes of imaging the fingerprint and a very low percentage of sensors of another technology that samples the fingerprint sparsely for the purposes of spoof detection or detection of the presence of the fingerprint. By way of example, consider an array that has 50.8 μm pixels wherein every area of 20×20 pixels (roughly 1×1 mm²) contains a pixel with an electrical sensor. One mode of operation for such an array is to only read out the sparse electrical sensor array by the processor(s) and when the analog signals received falls within the expected values for a finger (for example impedance values at certain AC frequencies), the optical sensor array is turned on to read the actual fingerprint by the processor(s).

TFTs, since they use amorphous silicon rather than crystalline silicon, can be printed on flexible substrates. Flexible substrates can be advantageous since they can allow more compact fingerprint scanners wherein folds or rolls up when not in use. Alternately, these flexible substrates can be fabricated in a “sling-like” configuration suitable for capture of rolled print equivalents. Flexible TFT-based arrays can be made very thin in order to accommodate “smart ID card” applications.

A surface of the second substrate facing the first substrate may be the top of the substrate in the sandwich light assembly of the first and second substrates and the array disposed there between. Alternatively, the surface of the first substrate opposite the array formed thereupon may be the top of the substrate, in this case the sensor may be considered “up-side-down”, in which case a metal (like steel or aluminum) plate or substrate may be provided as part of the assembly. Thus, the array may be printed where the second substrate is considered the bottom of the sensor. The TFT is printed on top of the first substrate and the light to be collected comes from above the sensor. However, if the TFT needs to be encapsulated with a gel or epoxy, trapped air bubbles will hinder light coming from the object and reach the TFT sensor. By printing the sensor “upside-down” one avoids this potential issue. In other words, the sensor is made such that light is expected to be collected from the bottom on of first substrate. This way, if any encapsulating is required, trapped air bubbles will only affect the illumination light (and not even this if LEDs or OLEDs are present at each pixel in the array. This and can thus increase optical resolution of a scanner utilizing the sensor. The metal plate may encapsulate the “upside down” sensor, and strengthen the sensor as well as to act as a heat sink for temperature stabilization.

Other functional finger print technologies include those described in Published U.S. Published Patent Application Document Nos. 20120308092 (Benkley); 20100286931 (Semba); 20120086794 (Burcham); 20110064282 (Abramovich); 0100046810 (Yamada); 20080159602 (Zank); 20080015032 (Bradford) which describes a method for verifying an identity of a patron, the method comprising: receiving fingerprint data from a fingerprint reader, wherein the fingerprint reader is in communication with a user interface controller, and wherein the user interface controller is retrofitted to a gaming machine and utilizes a preexisting bill acceptor connection to communicate with a processor board; receiving data received from a secondary source, wherein the secondary source is in communication with the user interface controller; comparing the fingerprint data to data received from the secondary source; and transmitting a verification message from the user interface controller to the processor board after the comparison of the fingerprint data to the data received from the secondary source.

In exemplary embodiments, in terms of hardware architecture, a computer includes a processor, memory coupled to a memory controller, and one or more input and/or output (I/O) devices (or peripherals) that are communicatively coupled via a local input/output controller. The input/output controller can be, but is not limited to, one or more buses or other wired or wireless connections, as is known in the art. The input/output controller may have additional elements, which are omitted for simplicity, such as controllers, buffers (caches), drivers, repeaters, and receivers, to enable communications. Further, the local interface may include address, control, and/or data connections to enable appropriate communications among the aforementioned components. The processor is a hardware device for executing software, particularly that stored in memory. The processor can be any custom made or commercially available processor, a central processing unit (CPU), an auxiliary processor among several processors associated with the computer 2201, a semiconductor based microprocessor (in the form of a microchip or chip set), a macroprocessor, or generally any device for executing software instructions.

The memory can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory may incorporate electronic, magnetic, optical, and/or other types of storage media. Note that the memory can have a distributed architecture, where various components are situated remote from one another, but can be accessed by the processor.

The software in memory may include one or more separate programs, each of which comprises an ordered listing of executable instructions for implementing logical functions. In the software in the memory may be included a fingerprint acquisition and processing methods described herein in accordance with exemplary embodiments and a suitable operating system (OS). The OS essentially controls the execution of other computer programs, such the contactless fingerprint acquisition and processing systems and methods as described herein, and provides scheduling, input-output control, file and data management, memory management, and communication control and related services.

The contactless fingerprint acquisition and processing methods described herein may be in the form of a source program, executable program (object code), script, or any other entity comprising a set of instructions to be performed. When a source program, then the program needs to be translated via a compiler, assembler, interpreter, or the like, which may or may not be included within the memory to operate properly in connection with the OS. Furthermore, the contactless fingerprint acquisition and processing methods can be written as an object oriented programming language, which has classes of data and methods, or a procedure programming language, which has routines, subroutines, and/or functions.

In exemplary embodiments, a conventional keyboard and mouse can be coupled to the input/output controller. Other output devices such as the I/O devices may include input devices, for example but not limited to a printer, a scanner, microphone, and the like. Finally, the I/O devices may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. For example, a proximity card reader may be included. Other devices such as a PIN keypad, microphone for voice analysis, camera for iris scan, or other biometric identifier should be included. The system can further include a display controller coupled to a display. In exemplary embodiments, the system can further include a network interface for coupling to a network. The network can be an IP-based network for communication between the computer and any external server, client and the like via a broadband connection. The network transmits and receives data between the computer and external systems, such as external fingerprint servers as described herein. In exemplary embodiments, network 2265 can be a managed IP network administered by a service provider. The network may be implemented in a wireless fashion, e.g., using wireless protocols and technologies, such as WiFi, WiMax, etc. The network5 can also be a packet-switched network such as a local area network, wide area network, metropolitan area network, Internet network, or other similar type of network environment. The network may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer is a PC, workstation, intelligent device or the like, the software in the memory may further include a basic input output system (BIOS) (omitted for simplicity). The BIOS is a set of essential software routines that initialize and test hardware at startup, start the OS, and support the transfer of data among the hardware devices. The BIOS is stored in ROM so that the BIOS can be executed when the computer is activated.

When the computer is in operation, the processor is configured to execute software stored within the memory, to communicate data to and from the memory, and to generally control operations of the computer pursuant to the software. The contactless fingerprint acquisition and processing methods described herein and the OS, in whole or in part, but typically the latter, are read by the processor, perhaps buffered within the processor, and then executed.

When the systems and methods described herein are implemented in software, the methods can be stored on any computer readable medium, such as storage, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In exemplary embodiments, where the contactless fingerprint acquisition and processing methods are implemented in hardware, the contactless fingerprint acquisition and processing methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include the ability to acquire fingerprint images at varying distances. The systems and methods described herein further provide identification and verification of individual fingerprints, providing both an indication to whom the fingerprint belongs as well as a confirmation of whether a fingerprint is the fingerprint of the individual asserting to be a certain person.

One embodiment generally includes a network, which may be a conventional Ethernet LAN, interconnecting a Player Account Server (“PAS”), one or more cashier terminals (“CT”), optional mobile cashier terminals (“MCT”) connected by a radio (“R.F.”) link, optional Point Of Sale Network Controller (“POSNC”) connected to a Point of Sale Terminal (“POST”), one or more logical game controllers (“LGC”), one or more cash exchange terminals, and a plurality of player terminals (“PT”). The PAS may consist of a COMPAQ 1850R database server using the Windows NT operating system and the Microsoft SQL 7.0 database software. The POSNC and the POST may consist of computer components and software available from companies such as MICROS Technologies. An Ethernet hub or switch (“HUB”), such as a 3COM model 3300, on the LAN connects directly with the PAS, CT, MCT through the radio link (Aironet or WiFi), and LGC; and in turn the LGC connects the plurality of securely packaged PTs, and CET into the LAN in a fashion well known to those skilled in the art using Ethernet or RS-485 connection techniques.

One embodiment of the CT has a central computer. Mounted on the central computer are conventional Ethernet input and output ports, a bar code reader (Metrologic model MS6720), a base video display (Miracle M0935), an eye level tower display (Logic Controls), a ticket printer (Transact Technology, of Wallingford, Conn., Series 700 Thermal Printer), standard PC keyboard and RS232 controlled industry standard point of sale cash and voucher drawer One preferred player terminal PT includes a central PC or equivalent motherboard connected to and supporting a visual display, push or game buttons, a combination voucher and currency reader (JCM WBA 13SS), conventional gaming network LAN input/output ports or communication interface, and ticket printer (Transact Technology Series 700 Thermal Printer). Optionally, the PT includes the fingerprint scanner as an LED or TFT scanner and may include a coin dispenser (Akahi-Seiko) in order to dispense cash awards or bonus tokens. The construction of the PT in conjunction with this specification is well known to those skilled in the art.

Preferably, the voucher (TITO ticket) 0 reports the date and time that the voucher or ticket was issued. It also identifies the issuing device CT, MCT, CET, or PT (“VLT”) that issued the ticket, and a ticket number. The ticket also states an amount or face value of the ticket when issued by the CT, MCT, CET, or PT as applicable. Finally, the ticket 50 also includes a bar code 52 and possibly a QR code 51 that has a variety of fields representing the above noted data stated on the face of the ticket 50.

The bar code 52 and QR code 51 also imbeds an encoded value, which is derived as a function of the information on the ticket, including the amount. Since this field is compressed, the algorithm does not allow for the reverse calculation. This value can also be used to confirm that a ticket is being redeemed for the correct amount, because the algorithm can be recalculated and checked. Such algorithms are well known to those skilled in the art; and the applicants believe that a wide number of such techniques may be utilized equally well. The ticket 50, thus contains information to provide for checking the authenticity of the ticket 50 as it is being used by the player in the present system. This also provides a mechanism whereby a ticket may be validated for redemption, even when access to the database is denied through network or other failure. The QR code may direct the system to a player account and may include player secur=ity account information, including direction to a stored fingerprint at the casino and/or the financial institution supporting the eWallet.

What is claimed:

1. A system for enabling transfer of available credit between a gaming apparatus and a non-banking internet source of credit comprising:
a gaming apparatus having a ticket-in-ticket-out reading and printing module;
an electronic wallet wireless communication system having a wireless communication link to an electronic wireless transaction facilitator;
a fingerprint scanner; and
a processor;
wherein the ticket-in-ticket-out module, the electronic wallet wireless communication system and fingerprint scanner are within a single housing for the gaming apparatus and wherein communication from the processor to the electronic wireless transaction facilitator requires a) scanning of a finger print, b) transmission of scanned fingerprint data to the processor, c) transmission of the scanned fingerprint data to the electronic wireless transaction facilitator; and d) approval from the electronic wireless transaction facilitator is returned to the processor; and
wherein a further requirement of communication between the processor and the electronic wireless transaction facilitator requires processor verification of existence of current available credit on the gaming apparatus; and
a user of the gaming apparatus transfers credit from the electronic wireless transaction facilitator to the gaming apparatus or from the gaming apparatus to the electronic wireless transaction facilitator.

2. The system of claim 1 wherein verification of credit available for transmission to the electronic wireless transaction facilitator is made by scanning of a ticket by the ticket-in-ticket-out reading system, and transmission of scanned data from the ticket identifying positive credit to the electronic wireless transaction facilitator and crediting to the electronic wireless transaction facilitator up to an amount validated as positive credit from the ticket.

3. The system of claim 1 wherein verification of credit available for transmission to the electronic wireless transaction facilitator is made by indication by the processor of available positive credit from the ticket.

4. The system of claim 1 wherein transmission of credit from the electronic wireless transaction facilitator to the processor is configured to pass credit in electronic wireless transaction facilitator to an established player account at a casino, a server accessible to the casino configured to maintain the player account and the server then configured to transmit credit from the player account to the gaming apparatus.

5. The system of claim 1 wherein the electronic wireless transaction facilitator comprises a server having an accounting function associated with an electronic wallet.

6. The system of claim 5 wherein the server stores fingerprint identification data and is configured to compare the scanned fingerprint data from the processor with stored identification data to provide authentication of player identity.

7. The system of claim 2 wherein the electronic wireless transaction facilitator comprises a server having an accounting function associated with an electronic wallet.

8. The system of claim 7 wherein the server stores fingerprint identification data and is configured to compare the scanned fingerprint data from the processor with stored identification data to provide authentication of player identity.

9. The system of claim 4 wherein the electronic wireless transaction facilitator comprises a server having an accounting function associated with an electronic wallet.

10. The system of claim 9 wherein the server stores fingerprint identification data and is configured to compare the scanned fingerprint data from the processor with stored identification data to provide authentication of player identity.

11. A method of transferring funds from an electronic wireless transaction facilitator to gaming apparatus with steps comprising:
a) a player at a gaming apparatus requesting a transfer of funds;
b) the player initiating transfer by scanning a player fingerprint at the gaming apparatus;
c) transmitting data of the scanned fingerprint to an electronic wireless transaction facilitator;
d) the electronic wireless transaction facilitator verifying data of the scanned fingerprint data with stored records of the electronic wireless transaction facilitator clients;
e) the electronic wireless transaction facilitator having a processor that executes code to verify data of the scanned fingerprint data with stored records of the electronic wireless transaction facilitator clients;
f) the gaming apparatus having a processor configured to provide authenticated credit data, and the gaming apparatus processor sending authentication of player identity to the gaming apparatus;
the method further comprising either:
A) an account accreditation step wherein:
g) the gaming apparatus either:
I) accepting a ticket in a ticket-in-ticket-out reader/scanner at the gaming apparatus to provide at least initial authorization of available credit indicated on the ticket;
II) identifying available credit at the gaming apparatus;
h) transmitting verification of available credit from i) or ii) to the electronic wireless transaction facilitator; and
i) crediting an account for the player in the electronic wireless transaction facilitator; or
B) a gaming apparatus accreditation step wherein:
j) the electronic wireless transaction facilitator verifying to the processor availability of funds for transfer to credits available to the gaming apparatus; and
k) upon demand from the processor at the gaming apparatus, transferring credit for use by the player at the gaming apparatus.

12. The method of claim 11 wherein transfer of credit to the gaming apparatus automatically initiates printing of a scanner readable ticket identifying an amount of credit available for deposit.

13. The method of claim 11 wherein transfer of credit to the gaming apparatus transfers available credit to the processor in the gaming apparatus, and then the gaming apparatus initiates printing of a scanner readable ticket identifying an amount of credit available for deposit.

14. The method of claim 11 wherein the electronic wireless transaction facilitator comprises a server having an accounting function associated with an electronic wallet.

15. The method of claim 12 wherein the electronic wireless transaction facilitator comprises a server having an accounting function associated with an electronic wallet.

15. The method of claim 13 wherein the electronic wireless transaction facilitator comprises a server having an accounting function associated with an electronic wallet.
